(19) United States
(12) Patent Application Publication
(10) Pub. No.: US 2009/0300983 A1
(43) Pub. Date: Dec. 10, 2009

(54) Solar hybrid agricultural greenroom

(76) Inventors: Arthur Robert Tilford, Yorba Linda, CA (US); Philip Frank Zimmermann, Long Beach, CA (US)

Correspondence Address: ARTHUR ROBERT TILFORD, 5975 CALLE ENTRADA, YORBA LINDA, CA, 92887-3532, US

(21) Appl. No.: 12/455,441

(22) Filed: Jun. 2, 2009

Related U.S. Application Data
(60) Provisional application No. 61/131,328, filed on Jun. 6, 2008.

(51) Int. Cl. A01G 9/00; A01G 31/02; A01G 9/14

(52) U.S. Cl. 47/60; 47/17; 47/58.1 LS

(57) ABSTRACT

The invention is a methodology and device to accept sunlight that is concentrated, modified and filtered to wavelengths known to promote rapid growth, flowering, and fruiting of plants. Such modified light is introduced into the invented chamber which allows the control of factors such as temperature and humidity, CO2 levels, air circulation, and the circulation of water and nutrients. In its preferred embodiment, the invention will use a portion of the collected light to power an array of photovoltaic (PV) chip arrays with the chamber to provide sufficient electricity to power the fans, pumps, and sensors employed within the growing chamber, making it totally self-sufficient once water, nutrients, and seedlings have been introduced into the system. The system may be used within a solid soil or hydroponics growth system.

### PRIOR APPLICATIONS

This application is based on provisional application No. 61/131,328 filed Jun. 6, 2008, and claim is made for the benefit of the filing date of the provisional application.

### FIELD OF THE INVENTION

This invention relates to gathering, concentrating and filtering solar light to enhance, modify, and promote plant growth within a portable, sealed agricultural growing chamber.

REFERENCES CITED

| | | | |
|---|---|---|---|
| 4,302,069 | November, 1981 | Niemi | 385/46 |
| 4,316,048 | February, 1982 | Woodall | 136/253 |
| 4,389,085 | June, 1983 | Mori | 359/591 |
| 4,422,719 | December, 1983 | Orcutt | 385/123 |
| 4,425,907 | January, 1984 | Younghouse | 126/685 |
| 4,460,940 | July, 1984 | Mori | 362/558 |
| 4,471,412 | September, 1984 | Mori | 362/565 |
| 4,765,701 | August, 1988 | Cheslak | 362/560 |
| 4,805,984 | February, 1989 | Cobb, Jr. | 385/133 |
| 4,806,289 | February, 1989 | Laursen, et al. | 264/1.29 |
| 4,822,123 | April, 1989 | Mori | 385/31 |
| 5,050,946 | September, 1991 | Hathaway, et al. | 385/33 |
| 5,054,869 | October, 1991 | Doyle | 385/133 |
| 5,060,119 | October, 1991 | Parthasarathy | 365/565 |
| 5,117,478 | May, 1992 | Cobb, Jr., et al. | 385/133 |
| 5,222,795 | June, 1993 | Hed | 362/558 |
| 5,271,077 | December, 1993 | Brockman, et al. | 385/31 |
| 5,298,327 | March, 1994 | Zarian, et al. | 428/373 |
| 5,309,544 | May, 1994 | Saxe | 385/146 |
| 5,463,706 | October, 1995 | Dumont, et al. | 385/32 |
| 5,465,493 | November, 1995 | Sobottke, et al. | 33/286 |
| 5,500,054 | March, 1996 | Goldstein | 136/253 |
| 5,631,994 | May, 1997 | Appeldorn, et al. | 385/147 |
| 5,716,442 | February, 1998 | Fertig | 136/246 |
| 5,836,669 | November, 1998 | Hed | 362/92 |
| 6,057,504 | May, 2000 | Izumi | 136/246 |
| 6,289,150 | September, 2001 | Zarian, et al. | 385/31 |
| 7,021,810 | April, 2006 | Hoffman | 362/577 |
| 7,164,819 | January, 2007 | Jenson, et al. | 385/39 |

### BACKGROUND OF THE INVENTION

Although the invention can be utilized in a soiled system, a hydroponics system offers certain advantages which this invention makes use of. The term hydroponics is derived from the Greek words for water and work. There is evidence to suggest that the Hanging Gardens of Babylon employed a form of non-soil gardening, but the real science was not done until 1860 in Germany. A professor named Gericke at the University of California, Berkeley is credited with coining the term ‘hydroponics” in 1940. The technology was used during World War Two by the U.S. military to provide fresh fruits and vegetables for the troops on Pacific islands that were largely devoid of soil. The first large scale commercial use was on Wake Island where Pan American Airlines had its refueling facility for their trans-Pacific routes. There was no soil on Wake, so hydroponics was employed to grow fruits and vegetables for the passengers because bringing in fresh produce was not economically feasible.

Controlled Environment Agricultural (“CEA”) is sometimes used interchangeably with hydroponics and while hydroponics falls in the CEA category, not all CEA is hydroponics with most common greenhouse operations falling outside the definition of hydroponics. The technology had its problems over the years. Some, like the high cost of concrete growing beds, were solved by the emergence of plastics. Others, like spikes in energy costs that made heating the greenhouses prohibitively expensive, were not easily solvable.

Currently, hydroponics are employed by large scale commercial operations growing the high value crops such as tomatoes and spices, while the remainder of the installations are hobbyists who utilize the technology to grow various plants for their own consumption. The big commercial operations are typically sited in areas where the light levels are highest such as Southern California and Arizona in desert regions where land is less expensive. The solar energy available in such areas enables high levels of photosynthetic activity resulting in rapid plant growth and high yields.

The downside to this abundance of solar energy is the heat it produces, thus requiring an array of venting and cooling strategies which consume energy to run. The hobbyist installations do not have massive greenhouses spread over many acres. Instead, they employ ‘grow lamps’, either incandescent or fluorescent to generate the light energy required to promote photosynthesis. This can be very effective, but there is a high cost in electricity to run these specialized lamps and they also create high levels of ambient heat that must be dealt with at an additional set of costs.

Whether the farming is done in open fields or in large CAE/hydroponic facilities, most produce farming is done in areas such as Southern California where the San Joughin and Imperial Valleys supply over 80% of the fruits and vegetables for the entire country at certain times of year.

In winter months, the United States imports massive amounts of produce from countries such as Mexico and Chile. As a direct result, a significant portion of the cost of food is comprised of the costs of transporting it to distant markets. Moving agricultural products over hundreds and thousands of miles to market expends massive amounts of irreplaceable fossil fuels and also results in the creation of large amounts of greenhouse emissions.

Another difficulty with traditional soil based agriculture is the use of pesticides that help to protect the growing plants from insects. Other chemicals are used to fight crop diseases and enhance the nutrient value of the soil. These chemicals are part of the agricultural runoff that has been shown to pollute rivers, streams, and the groundwater in the aquifers.

The present invention utilizes light carrying conduits for the establishment of exact light placement in relation to plant locations. The movement of light through conduits has been utilized successfully for the purpose of local illumination, remote illumination and image projection. Transporting light via conduits such as pipes and light guides has provided the means whereby a light source at one location could provide illumination to one or various other locations without the need of energy conversion.

Previous art is found among many U.S. patents related to light transport methods. Niemi has disclosed, in patent U.S. Pat. No. 04,302,069, an illumination system incorporating light pipes distributing light to large numbers of building spacial units, the system employing reflector cones, lenses, and a pyramid shaped reflector. Woodall teaches, in U.S. Pat. No. 04,316,048, a system whereby receiving input energy in thermal or radiant form is absorbed, stored, and then released for use. While this teaching plainly discusses only the use of geometric structures as light manipulation devices, Orcuft, in patent U.S. Pat. No. 04,422,719, goes further to teach the use of a flexible transmitting guide with a transparent semi-solid core to which is shrink-fitted, or otherwise tightly clad, a transparent or translucent sleeve which is designed to laterally diffuse, disperse or refract a substantial component of light away from the core as it traverses the length of the guide with the use of interposing cuts or discontinuities at intervals along its surface, or otherwise containing an emulsion of light-reflecting particles all for the purpose of external illuminations.

Mori had produced many patents, four of which have special interest in their teaching of light transport. Mori's patent U.S. Pat. No. 04,389,085 teaches a lighting system utilizing an optical transmission line consisting of optical conductor means with light diffusion holes for transmitting and redistributing the focused sun rays to at least one desired point. In another of his patents, U.S. Pat. No. 04,460,940, Mori teaches of a light diffusing device whereby light comes out from the device through the light diffusing layer of differing thickness. In another patent, U.S. Pat. No. 04,471,412, Mori teaches of an illumination element having a transparent flexible tube and a fine flexible light conducting member accommodated in the tube. The light conducting member is provided with a number of light outlet sections at spaced locations along its length. Light is incident on at least one end of the light conducting member and caused to break through the light outlet sections while propagating through the light conducting member for ornamental lighting or the like. In another patent, U.S. Pat. No. 04,822,123, Mori teaches of an optical radiator for diffusing radiating sunlight emitted from an optical-conductor cable for the purpose of illumination. In order to illuminate a sufficiently wide region surrounding the optical-conductor cable, a cladding layer of the optical-conductor cable located in the region to be illuminated is excised, and the outer surface of the thus exposed core of the optical-conductor cable is topically covered by a fine grain adhesive with a refractive index equal to or greater than that of said core. The resulting adhesive elements are relatively densely distributed toward a downstream direction and thinly distributed upstream, or the adhering area of the elements is selected to be smaller upstream and larger downstream.

The use of a light carrying wave guide is further taught by Younghouse in his patent U.S. Pat. No. 04,425,907 where he teaches of a system for the collection of electromagnetic radiation and the transmission of that radiation to a point of use. In its simplest sense, an apparatus for the collection and transmission of electromagnetic radiation comprises a cylindrical fluorescent fiber, at least one end of which is optically coupled to an optical wave guide, and means for reflecting solar radiation impinging over a relatively wide area onto said cylindrical fluorescent fiber. Preferably, a compound parabolic mirror is employed for reflecting incident solar radiation onto the optical fluorescent fiber. Cheslak teaches in patent U.S. Pat. No. 04,765,701 about an illuminator formed from an optically transmissive body which is characterized by internal reflection and which has formed at discrete locations along its length one or more recesses. Each of these recesses includes two opposing surfaces which depend angularly inward from the body to define an included angle there between to a panel formed with discrete locations of transparency which are positioned contiguous to one or more of the recesses to insure that light passing out from the illuminator will be directed through the transparent location of the panel.

Laursen teaches of a method for making a hollow light conducting pipe in patent U.S. Pat. No. 04,806,289 by the co-extrusion of polymeric materials. The hollow light conductor comprises a continuous annular core layer encased in inner and outer cladding layers. Cobb Jr. demonstrates of the internal reflecting capability of a light conduit in patent U.S. Pat. No. 04,805,984 where he uses a linear array of substantially right angled isosceles prisms arranged side-by-side to form grooves. He further teaches in patent U.S. Pat. No. 05,117,478 of the use of thin transparent prismatic elements for the re-directing of light from one conduit to another conduit. Hathaway utilizes a different approach in patent U.S. Pat. No. 05,050,946 where he teaches of the use of a light pipe with a stair-stepped or faceted back surface which are angled so that the injected light reflects off the facets and through the front surface. Doyle teaches of a light pipe having a maximum radiation output in patent U.S. Pat. No. 05,054,869 where radiation losses due to absorbance are minimized by: (1) matching the area of the beam and the light pipe passage; (2) minimizing the number of reflectances of a given ray by reducing the angular divergence of radiation in the beam; and (3) using a reflective coating on the wall of the light pipe which has the low point of its reflectance curve at a relatively high grazing angle.

An improved optical light pipe for decorative illumination which accepts high intensity light at the ends of the light pipe, which refracts predominantly all of the propagating modes radially outwards of the light pipe and which has a central member for mechanical strength and mode scattering is taught by Parthasarathy in patent U.S. Pat. No. 05,060,119. A means for causing light to enter a light pipe is taught by Brockman in patent U.S. Pat. No. 05,271,077 where a reflector for coupling light from a light source into an optical waveguide includes input and output ends, a central axis and a reflecting surface disposed around the central axis. Hed teaches, in patent U.S. Pat. No. 05,222,795, of a controlled emission of light from an optical waveguide by modifying the periphery of the waveguide so that light emanates continuously over the length of the guide. Hed further teaches in patent U.S. Pat. No. 05,836,669 of the use of one or more light extractors in the form of wave guides provided along a surface with formations or the like from which light is emitted.

A plastic light conduit of cross-linked polymer material having good light transmitting characteristics, without voids or noticeable bubbles, is disclosed by Zarian in patent U.S. Pat. No. 05,298,327. Saxe in his patent U.S. Pat. No. 05,309,544, teaches of a light pipe which includes a tube with a structured outer surface and a smooth inner surface and a reflective light extractor which is positioned in the tube such that light reflected by the extractor will strike the tube on a first side. The first side has a contour such that the direction of travel of light reflected by the extractor will have a projection in the plane perpendicular to the optical axis that makes a predetermined angle with the smooth surface. Although many have taught of the necessity for an opaque outer clad over a light waveguide, Dumont, in his patent U.S. Pat. No. 05,463,706, teaches of a translucent jacket over a light transmission conduit for the purposes of visually identifying the conduit. Alternatively, Sobottke teaches of the use of a specific wavelength of light through a pipe for alignment of that pipe in patent U.S. Pat. No. 05,465,493. Goldstein teaches in his patent U.S. Pat. No. 05,500,054 of the use of radioactive particles within supermissive materials located at the contact between the outer clad and inner light pipe for the purpose of creating photons which then travel to pipe end where they are converted by photovoltaic cells into electricity.

In U.S. Pat. No. 05,631,994 patent, Appeldorn teaches of a structured surface which includes optical elements that have optically smooth surfaces disposed at an angle relative to the base surface which is optically coupled by the use of reflection with a portion of a surface of a light guide such that light may be transmitted from the optical fiber into a substrate for illumination. Fertig, in his patent U.S. Pat. No. 05,716,442, teaches of an energy conversion system using a light pipe that includes: one or more solar and/or artificial light sources; one or more opaque and/or transparent hollow tubular conduits; a reflective material means covering the inside surfaces of the hollow tubular conduits; a mirror at either end of the conduits and between any vertical and horizontal connecting joint sections; a plurality of photovoltaic cell arrays mounted on substrates, positioned inside the hollow tabular conduits, whereby part of the light energy source illuminates, and part of the light energy source is converted into electric energy. Izumi, in patent U.S. Pat. No. 06,057,504, teaches of a solar tracking panel assembly positioned outside containing many lenses for the purpose of separating light into shorter and longer wavelengths for electricity and heat generation. Zarian teaches in patent U.S. Pat. No. 06,289,150 of a means for obtaining side lighting from an optical conduit by making a plurality of illuminators that are formed by uniform cuts in the optical fiber core to emit reasonably even light perpendicularly along the length of the conduit outwardly from very narrow to very wide by altering the shape of the optical fiber core and/or by the cuts. Sylvester describes in patent U.S. Pat. No. 07,021,810 of a light distribution apparatus which includes a light distribution hub and at least one light source and color converter that is enclosed in a light house which converts the reference light wavelength emission to a converted light emission. Berger teaches of a device that includes a parabolic or hyperbolic lens that operates by receiving a uniform or non-uniform input light beam and produces a relatively uniform illumination of an illumination surface.

Jenson, in his patent U.S. Pat. No. 07,164,819, teaches of side-light extraction by light pipe-surface alteration and light-extraction devices extending radially beyond the outer cladding which includes an optical light pipe with a solid plastic light-carrying portion covered with a fluoropolymer cladding. A plurality of light-extraction devices is spaced along an active section of the light pipe for emission of side light over only a range from about 2 to 270 degrees of the cross-sectional circumference of the light pipe which may or may not have a change of cross section. The light-extraction devices have inlets passing through the cladding and optically contacting the plastic light-carrying portion.

All of the above mentioned teachings contain the technology to provide for the transport of light in some manner for the purpose of illumination or energy use. However, none of the above nor any of the known historic art provides for a teaching where light carrying photons are carefully guided through a hollow specifically shaped hexagonal light waveguide and that incorporate internally-wall-mounted solar cells circumnavigating the waveguide axis in a 360-degree manner with associated internal reflective components positioned in such a manner to allow the complete thru-put of some of the light while utilizing the remaining light in an economical manner where photovoltaic cells absorb such light within the waveguide itself. The necessity of creating a controlled 100% light tight environment where specific frequencies of light are utilized to their maximum in the modification and acceleration of plant growth was the purpose for the design of this invention.

### BRIEF SUMMARY OF THE INVENTION

The purpose of this invention is to eliminate as many of the negatives associated with conventional, soil based agricultural as possible while also allowing an unprecedented level of control over the entire growing process.

To achieve the desired level of control, it was decided to use a container that could be sealed to afford a closed environment. Other criteria included easy portability, weather resistance, affordability, and a commercially viable interior volume. Although this invention can utilize a wide variety of containers successfully, it was felt that decommissioned, refrigerated ocean containers were the best choice for a number of reasons.

These particular containers are available in both 20 and 40 foot lengths and the latter versions come with ceiling heights of either eight or nine plus feet. They are constructed primarily of aluminum and stainless steel so they could be airlifted if necessary to zones where there exists a risk of famine or other crisis situations. They can easily be moved by ship or truck to anywhere in the world where a need for food exists and their construction renders them impervious to almost any environmental conditions they may be placed in.

Because they were designed for refrigeration, these containers are well insulated and designed for continuous air circulation. They also feature very smooth interiors comprised of either aluminum or stainless thus rendering them efficient reflective surfaces.

Other considerations included price and ready availability. There are tens of millions of ocean containers in service today and their price, either new or used, is reflected in the economy of scale associated with such high levels of production.

Using tightly sealed containers for agriculture eliminates the effects of weather while also allowing total control of important factors such as temperature, humidity, and airflow. There is no danger of losses from birds or animals and any plant diseases would be limited to just the one container so infected. In this hermetically sealed environment, there is no need for any pesticides to control pests.

This same sealed environment allows for total control of the water and nutrients that are presented to the growing plants. The water introduced into the growing chambers is carefully filtered and controlled for pH, temperature, and the level of dissolved solids such as sodium, calcium, and magnesium is held to very low levels through the use of reverse osmosis filters.

Depending on the plants to be grown in the chamber, a mixture of water soluble nutrients will be added to the filtered water supply and then circulated around the roots of the plants being grown. Because pure water does not conduct electricity, it is possible to measure electrical conductivity (EC) to accurately determine the nutrient levels using electronic meters. This data is used to control the dosing valves within the chamber to maintain the nutrient mixtures at preset levels.

By definition, hydroponics does not employ soil as a growing medium. However, there are several inert mediums that can be used to provide root support and also hold and make available oxygen, water, and nutrients to the growing plants. These mediums include rockwool, vermiculite, pumice, gravel, sand, and expanded clay. Their advantages, drawbacks, and applications are well documented in the literature and it is up to each crop grower to choose the medium most suitable for the plants they plan to cultivate.

In the same vein, the various nutrient delivery systems are well established and documented. They include ebb and flow, aquaponics, top feed bucket systems and others. Each has it advantages depending on the plants to be grown. In each case, a system of pumps, timers, tubing, and reservoirs is used to present the aqueous nutrient solution to the roots of the growing plants at regular intervals.

Because the refrigerated containers are tightly sealed, it is possible to introduce carbon dioxide into the container to enhance growth rates. The average outdoor levels are now said to be approximately 380 parts per million (PPM) with higher levels in population centers. During those hours when the interior of the chamber is illuminated, plants will grow up to twice as rapidly if the CO2 levels are in the 1,000 to 2,000 PPM range. Infrared meters are used to continuously monitor the levels of CO2 in the container and computerized controls adjust them automatically.

The present invention accepts specifically filtered and modified light ducted into the growing chamber where it is directed toward the growing plants at the most favorable angles to maximize the growth potential. In this scheme the sunlight is available according to the time of year, however the available light can be concentrated to compensate for lower levels present during the shorter days of the year.

Due to their self-contained, weather proof construction, the modules can be installed in a wide variety of environments. In dense urban environments, their aluminum construction allows them to be helicopter-lifted to building tops. In very severe weather climes, they can be buried to a depth where the Earth's temperature is relatively constant. Once buried, conventional farming can be conducted at ground level, thus allowing true “dual use.”

With their closed design and ability to be equipped with a wide variety of sensors, the SHAG containers are ideal as “Greenrooms” for use in agricultural research projects.

### BRIEF DESCRIPTION OF THE DRAWINGS

FIG. 1 is an illustration of the light emitting array (LEA) as used in the embodiment of the present invention;

FIG. 2 is an illustration of the reflection orientation utilized in the light emitting array (LEA) as used in the embodiment of the present invention;

FIG. 3 is an illustration of the solar cell array (SCA) as used in the embodiment of the present invention;

FIG. 4 is an illustration of the light emitting array (LEA) as it appears partially in front of solar cell array (SCA) as used in the embodiment of the present invention;

FIG. 5 is an illustration of the complete light emitting array with solar cell array (LESCA) as used in the embodiment of the present invention;

FIG. 6 is an illustration of the LESCA positioned inside and at the ceiling of the agricultural plant growing chamber as used in the embodiment of the present invention;

FIG. 7 is an illustration of three of the LESCA units positioned inside and at the ceiling and two side walls of the agricultural plant growing chamber as used in the embodiment of the present invention;

FIG. 8 is an illustration of four of the LESCA units positioned inside and at the ceiling and three side walls of the agricultural plant growing chamber as used in the embodiment of the present invention;

FIG. 9 is an illustration of four of the LESCA units with three in modified position angles at the ceiling and two side walls of the agricultural plant growing chamber as used in the embodiment of the present invention.

### DETAILED DESCRIPTION

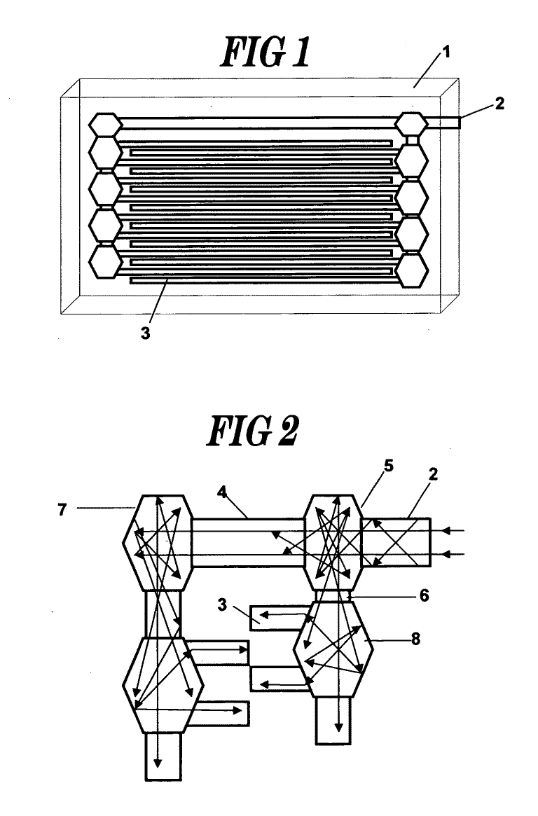

FIG. 1 illustrates the light emitting array (LEA) 1 with a single light input port 2 which allows the conduction of light directly to the several light emitting conduits 3.

FIG. 2 illustrates the internal light reflection orientation utilized in the light emitting array (LEA). Filtered and modified light enters the input port 2 and is transmitted through the first internal reflecting unit 5 to the primary non-emitting light conduit 4 where it is re-directed through a second internal reflecting unit 7. Light is also re-directed within the first internal reflecting unit 5 through a vertical non-emitting light conduit 6 to another internal reflecting unit 8 where it is re-directed to one of two light emitting conduits 3. It also passes through the internal reflecting unit 8 to another portion of the light emitting array where the process is repeated until all light emitting conduits are served.

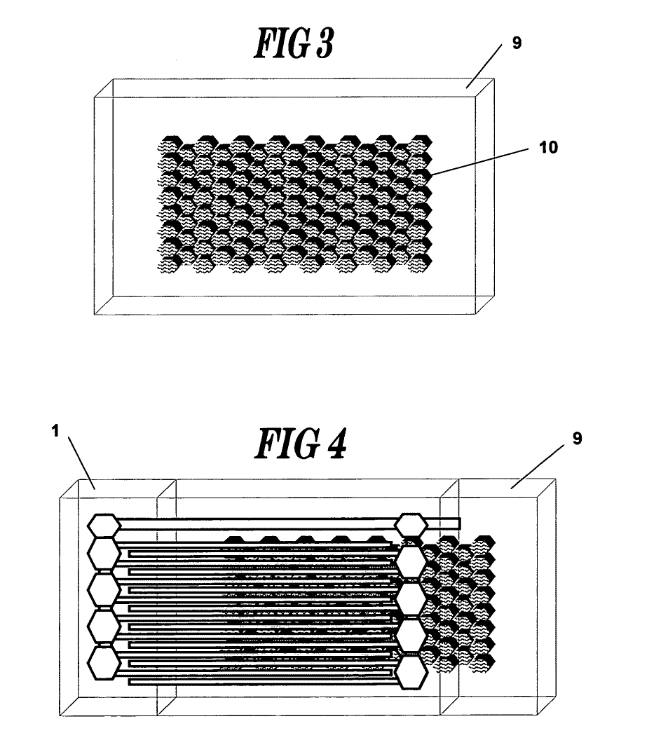

FIG. 3 illustrates the solar cell array (SCA) 9 which houses an array of solar cells 10.

FIG. 4 illustrates the manner in which the light emitting array (LEA) 1 is related to the solar cell array (SCA) 9. In this illustration the SCA 9 is being positioned behind the LEA 1.

FIG. 5 illustrates of the complete light emitting array with solar cell array (LESCA) 11 as used in the embodiment of the present invention.

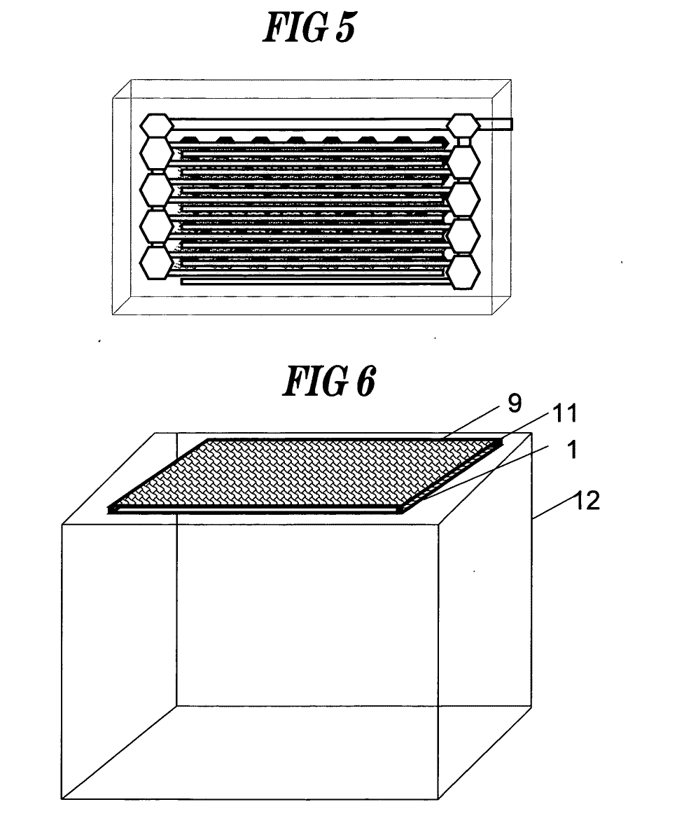

FIG. 6 illustrates of the LESCA 11 with LEA 1 facing the interior and SCA 9 on the back side of the LEA as positioned inside and at the ceiling of the agricultural plant growing chamber 12.

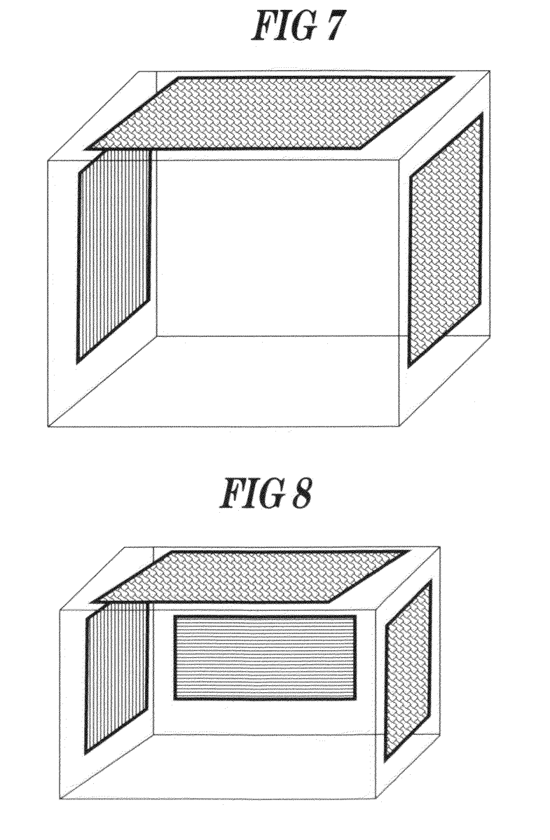

FIG. 7 illustrates three of the LESCA units positioned inside and at the ceiling and two side walls of the agricultural plant growing chamber.

FIG. 8 illustrates four of the LESCA units positioned inside and at the ceiling and three side walls of the agricultural plant growing chamber.

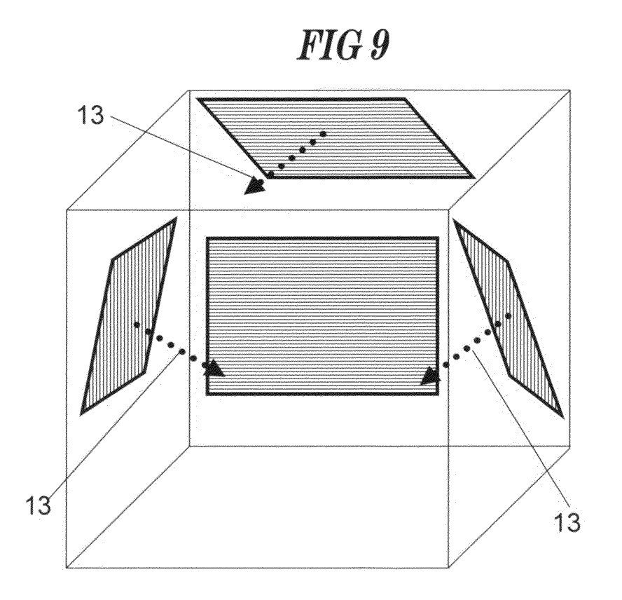

FIG. 9 illustrates four of the LESCA units with three in modified position angles with dotted arrows 13 indicating light direction as emitted at the ceiling and two side walls of the agricultural plant growing chamber.

What is claimed is:

1. A self-contained opaque plant growing chamber which provides external natural solar light internally in the most favorable amounts and directed toward all growing plants as well as photovoltaic cells within the chamber at the most favorable angles to maximize the plant growth potential and to provide self-sustaining electrical power.

2. A self-contained opaque plant growing chamber which provides external natural solar light internally in the most favorable amounts and directed toward all growing plants within the chamber at the most favorable angles to maximize the plant growth potential.

3. The said opaque plant growing chamber of claim 2 further comprises a light input port to allow the reception of said external natural solar light into the said opaque plant growing chamber.

4. The said opaque plant growing chamber of claim 2 further comprises a series of light transmitting conduits containing internal reflectors for the purpose of placing said external natural solar light into appropriate positions within the said opaque plant growing chamber.

5. The said opaque plant growing chamber of claim 2 further comprises a series of light emitting conduits appropriately positioned within the chamber at said most favorable angles for plant growth.

6. A self-contained opaque chamber which provides external natural solar light internally in the most favorable amounts and directed toward a series of photo voltaic cells appropriately positioned within the chamber for the conversion of light into electricity.

7. The said opaque chamber of claim 6 further comprises a light input port to allow the reception of said external natural solar light into the said opaque chamber.

8. The said opaque chamber of claim 6 further comprises a series of light transmitting conduits containing internal reflectors for the purpose of placing said external natural solar light into appropriate positions within the said opaque chamber.

9. The said opaque chamber of claim 6 further comprises a series of light emitting conduits appropriately positioned within the chamber at said most favorable angles toward said photovoltaic cells.
